(19) United States
(12) Patent Application Publication
(10) Pub. No.: US 2026/0061865 A1
(43) Pub. Date: Mar. 5, 2026

(54) METHOD TO IMPROVE CHARGING SPEED USING ONBOARD ALTERNATING CURRENT GENERATION

(71) Applicant: GM Global Technology Operations LLC, Detroit, MI (US)

(72) Inventors: Shuonan Xu, Troy, MI (US); Neeraj S. Shidore, Novi, MI (US); Chandra S. Namuduri, Troy, MI (US); Jian Gao, Auburn Hills, MI (US); Renato Amorim Torres, Pontiac, MI (US)

(21) Appl. No.: 18/824,359

(22) Filed: Sep. 4, 2024

(51) Int. Cl. B60L 53/20; B60L 53/10; B60L 53/62

(52) U.S. Cl. CPC B60L 53/20; B60L 53/11; B60L 53/62; B60L 2210/40

(57) ABSTRACT

A vehicle includes an electrical system performing a method of charging a battery of the vehicle. The electrical system includes the battery, an inverter coupled to the battery via a positive bus line, a first contactor within the inverter that connects the battery to the inverter via the positive bus line, a charge port for connecting the positive bus line to a charging station for receiving a baseline charging current from the charging station, a diode for preventing a reverse flow of current from the electrical system to the charging station, and a processor. The processor is configured to control the first contactor to generate a ripple current in the positive bus line, wherein the ripple current is superimposed over the baseline charging current to obtain a combined charging current, wherein the combined charging current is used to charge the battery.

The subject disclosure relates to charging of electric vehicles and, in particular, to a system and method for improving charging speed.

Electrical vehicles require periodic charging in order to replenish their batteries. Charging generally includes a constant current phase followed by a constant voltage phase. The constant voltage phase can take an undesirably long time. The charging speed for lithium-ion batteries, in particular, is limited by the occurrence of lithium plating, especially at lower temperatures. Pulse charging has been shown to improve charging speeds. However, this requires a ripple current to be generated either from the charging source, which may or may not be equipped for ripple current generation, or by installing additional hardware to the vehicle.

Accordingly, it is desirable to generate a ripple current using existing circuitry of the vehicle.

### SUMMARY

In one exemplary embodiment, a method of charging a battery of a vehicle is disclosed. A baseline charging current is received from a charging station coupled to an electrical system of the vehicle, the electrical system including the battery, an inverter, and a positive bus line connecting the battery to the inverter and connecting the battery to the charging station. The inverter includes a first contactor for connecting the battery and the inverter along the positive bus line. The first contactor is controlled to generate a ripple current on the positive bus line. The ripple current is superimposed over the baseline charging current to obtain a combined charging current. The battery is charged using the combined charging current.

In addition to one or more of the features described herein, wherein a charging operation includes a constant current phase, the method further includes charging the battery using the combined charging current during the constant current phase.

In addition to one or more of the features described herein, wherein the electrical system includes a second contactor between the positive bus line and a midpoint of a branch of the inverter, the method further includes controlling the first contactor and the second contactor to generate the ripple current.

In addition to one or more of the features described herein, wherein a charging operation includes a constant current phase and a constant voltage phase, the method further includes charging the battery using the combined charging current to reduce a duration of the constant voltage phase.

In addition to one or more of the features described herein, the method further includes controlling an amplitude of the ripple current to perform at least one of inhibiting an occurrence of plating at the battery and heating the battery.

In addition to one or more of the features described herein, the method further includes applying heat to the battery via at least one of an external heat source and the ripple current.

In addition to one or more of the features described herein, the method further includes providing the baseline current at a first power, superimposing the ripple current over the baseline current to generate the combined charging current at the first power, and increasing the combined charging current from the first power to a second power greater than the first power.

In another exemplary embodiment, an electrical system of a vehicle is disclosed. The electrical system includes a battery, an inverter coupled to the battery via a positive bus line, a first contactor within the inverter that connects the battery to the inverter via the positive bus line, a charge port for connecting the positive bus line to a charging station for receiving a baseline charging current from the charging station, and a processor. The processor is configured to control the first contactor to generate a ripple current in the positive bus line, wherein the ripple current is superimposed over the baseline charging current to obtain a combined charging current for charging the battery.

In addition to one or more of the features described herein, a charging operation includes a constant current phase and the processor is further configured to charge the battery using the combined charging current during the constant current phase.

In addition to one or more of the features described herein, the electrical system includes a second contactor between the positive bus line and a midpoint of a branch of the inverter and the processor is further configured to control the first contactor and the second contactor to generate the ripple current.

In addition to one or more of the features described herein, a charging operation includes a constant current phase and a constant voltage phase and the processor is further configured to charge the battery using the combined charging current to reduce a duration of the constant voltage phase.

In addition to one or more of the features described herein, the processor is further configured to control an amplitude of the ripple current to perform at least one of inhibiting an occurrence of plating at the battery and heating the battery.

In addition to one or more of the features described herein, heat is applied to the battery via at least one of an external heat source and the ripple current.

In addition to one or more of the features described herein, the processor is further configured to provide the baseline current at a first power, superimpose the ripple current over the baseline current to generate the combined charging current at the first power, and increase the combined charging current from the first power to a second power greater than the first power.

In yet another exemplary embodiment, a vehicle is disclosed. The vehicle includes an electrical system. The electrical system includes a battery, an inverter coupled to the battery via a positive bus line, a first contactor within the inverter that connects the battery to the inverter via the positive bus line, a charge port for connecting the positive bus line to a charging station for receiving a baseline charging current from the charging station, a diode for preventing a reverse flow of current from the electrical system to the charging station, and a processor. The processor is configured to control the first contactor to generate a ripple current in the positive bus line, wherein the ripple current is superimposed over the baseline charging current to obtain a combined charging current, wherein the combined charging current is used to charge the battery.

In addition to one or more of the features described herein, a charging operation includes a constant current phase and the processor is further configured to charge the battery using the combined charging current during the constant current phase.

In addition to one or more of the features described herein, the electrical system includes a second contactor between the positive bus line and a midpoint of a branch of the inverter and the processor is further configured to control the first contactor and the second contactor to generate the ripple current.

In addition to one or more of the features described herein, a charging operation includes a constant current phase and a constant voltage phase and the processor is further configured to charge the battery using the combined charging current to reduce a duration of the constant voltage phase.

In addition to one or more of the features described herein, the processor is further configured to control an amplitude of the ripple current to perform at least one of inhibiting an occurrence of plating at the battery and heating the battery.

In addition to one or more of the features described herein, the processor is further configured to provide the baseline current at a first power, superimpose the ripple current over the baseline current to generate the combined charging current at the first power, and increase the combined charging current from the first power to a second power greater than the first power.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an embodiment of a vehicle in accordance with an exemplary embodiment;

FIG. 2 shows an electrical system of the vehicle of FIG. 1, in an illustrative embodiment;

FIG. 3 shows a circuit illustrating a charging operation for the vehicle, in an embodiment;

FIG. 4 shows a graph illustrating a relation between current and time during a charging operation;

FIG. 5 is a graph illustrating a relation between charging current and state of charge for different charging operations;

FIG. 6 is a diagram of an electrical system with multiple inverters and motors;

FIG. 7 shows a graph of charging power over time;

FIG. 8 shows a graph of state of charge (SOC) over time;

FIG. 9 is a graph showing a low amplitude ripple current that can be used for charging;

FIG. 10 is a graph showing a mid-range amplitude ripple current that can be used for charging;

FIG. 11 is a graph showing a high amplitude ripple current that can be used for charging;

FIG. 12 is a diagram showing a heating and pulse charging strategy;

FIG. 13 is a graph showing charging power for various charging methods for a cold battery; and

FIG. 14 is a graph showing battery temperatures for various charging methods for a cold battery.

### DETAILED DESCRIPTION

The following description is merely exemplary in nature and is not intended to limit the present disclosure, its application or uses. It should be understood that throughout the drawings, corresponding reference numerals indicate like or corresponding parts and features.

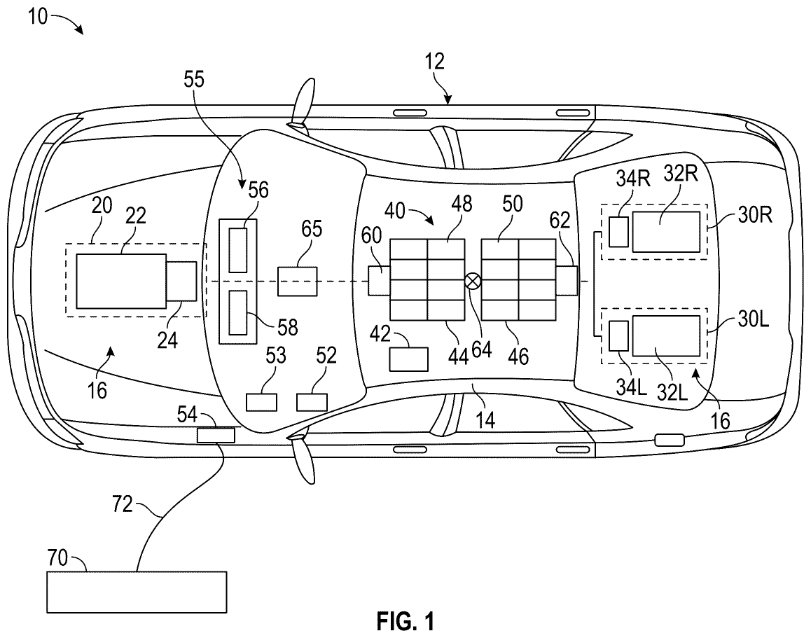

In accordance with an exemplary embodiment, FIG. 1 shows an embodiment of a vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and others.

The vehicle 10 may be an electrically powered vehicle (EV), a hybrid vehicle or any other vehicle. In an embodiment, the vehicle 10 is an electric vehicle that includes multiple motors and/or drive systems. Any number of drive units may be included, such as one or more drive units for applying torque to front wheels (not shown) and/or to rear wheels (not shown). The drive units are controllable to operate the vehicle 10 in various operating modes, such as a normal mode, a high-performance mode (in which additional torque is applied), all-wheel drive (“AWD”), front-wheel drive (“FWD”), rear-wheel drive (“RWD”) and others.

For example, the propulsion system 16 is a multi-drive system that includes a front drive unit 20 for driving front wheels, and rear drive units for driving rear wheels. The front drive unit 20 includes a front electric motor 22 and a front inverter 24 (e.g., front power inverter module or FPIM), as well as other components such as a cooling system. A left rear drive unit 30L includes a left rear electric motor 32L and a left rear inverter 34L. A right rear drive unit 30R includes a right rear electric motor 32R and a right rear inverter 34R. The front inverter 24, left rear inverter 34L and right rear inverter 34R (e.g., power inverter units or PIMs) each convert direct current (DC) power from a high voltage (HV) battery system 40 to poly-phase (e.g., two-phase, three-phase, six-phase, etc.) alternating current (AC) power to drive the front electric motor 22 the left rear electric motor 32L and the right rear electric motor 32R.

As shown in FIG. 1, the drive systems feature separate electric motors. However, embodiments are not so limited. For example, instead of separate motors, multiple drives can be provided by a single machine that has multiple sets of windings that are physically independent.

As also shown in FIG. 1, the drive systems are configured such that the front electric motor 22 drives the front wheels (not shown), and the left rear electric motor 32L and right rear electric motor 32R drive the rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In the propulsion system 16, the front drive unit 20, left rear drive unit 30L and right rear drive unit 30R are electrically connected to the battery system 40. The battery system 40 may also be electrically connected to other electrical components (also referred to as “electrical loads”), such as vehicle electronics (e.g., via an auxiliary power module or APM 42), heaters, cooling systems and others. The battery system 40 may be configured as a rechargeable energy storage system (RESS).

In an embodiment, the battery system 40 includes a plurality of separate battery assemblies, in which each battery assembly can be independently charged and can be used to independently supply power to a drive system or systems. For example, the battery system 40 includes a first battery assembly such as a first battery pack 44 connected to the front inverter 24, and a second battery pack 46. The first battery pack 44 includes a first plurality of battery modules 48, and the second battery pack 46 includes a second plurality of battery modules 50. Each of the first plurality of battery modules 48 and the second plurality of battery modules 50 includes a number of individual cells (not shown).

Each of the front electric motor 22 and the left rear electric motor 32L and right rear electric motor 32R is a three-phase motor having three phase motor windings. However, embodiments described herein are not so limited. For example, the motors may be any poly-phase machines supplied by poly-phase inverters, and the drive units can be realized using a single machine having independent sets of windings.

The battery system 40 and/or the propulsion system 16 includes a switching system having various switching devices for controlling operation of the first battery pack 44 and second battery pack 46, and selectively connecting the first battery pack 44 and second battery pack 46 to the front drive unit 20, left rear drive unit 30L and right rear drive unit 30R. The switching devices may also be operated to selectively connect the first battery pack 44 and the second battery pack 46 to a charging system. The charging system can be used to charge the first battery pack 44 and the second battery pack 46, and/or to supply power from the first battery pack 44 and/or the second battery pack 46 to charge another energy storage system (e.g., vehicle-to-vehicle (V2V) and/or vehicle-to-everything (V2X) charging). The charging system includes one or more charging modules. For example, a first onboard charging module (OBCM) 52 is electrically connected to a charge port 54 for charging to and from an AC system or device, such as a utility AC power supply. A second OBCM 53 may be included for DC charging (e.g., DC fast charging or DCFC). However, in various embodiments, an OBCM is not needed for DC fast charging.

The first OBCM 52 and/or the second OBCM 53 can be coupled to an electrical charging station 70 via an electrical cord 72 for charging the vehicle 10.

In an embodiment, the switching system includes a first switching device 60 that selectively connects to the first battery pack 44 to the front inverter 24, left rear inverter 34L and right rear inverter 34R, and a second switching device 62 that selectively connects the second battery pack 46 to the front inverter 24, left rear inverter 34L and right rear inverter 34R. The switching system also includes a third switching device 64 (also referred to as a “battery switching device”) for selectively connecting the first battery pack 44 to the second battery pack 46 in series.

Any of various controllers can be used to control functions of the battery system 40, the switching system and the drive units. A controller includes any suitable processing device or unit, and may use an existing controller such as a drive system controller, an RESS controller, and/or controllers in the drive system. For example, a controller 65 may be included for controlling switching and drive control operations as discussed herein.

The controller 65 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 65 may include a non-transitory computer-readable medium that stores instructions which, when processed by one or more processors of the controller 65, implement a method of performing pulse charging of a battery of the vehicle using equipment of the electrical system of the vehicle, according to one or more embodiments detailed herein.

The vehicle 10 also includes a computer system 55 that includes one or more processing devices 56 and a user interface 58. The computer system 55 may communicate with the charging system controller, for example, to provide commands thereto in response to a user input. The various processing devices, modules and units may communicate with one another via a communication device or system, such as a controller area network (CAN) or transmission control protocol (TCP) bus.

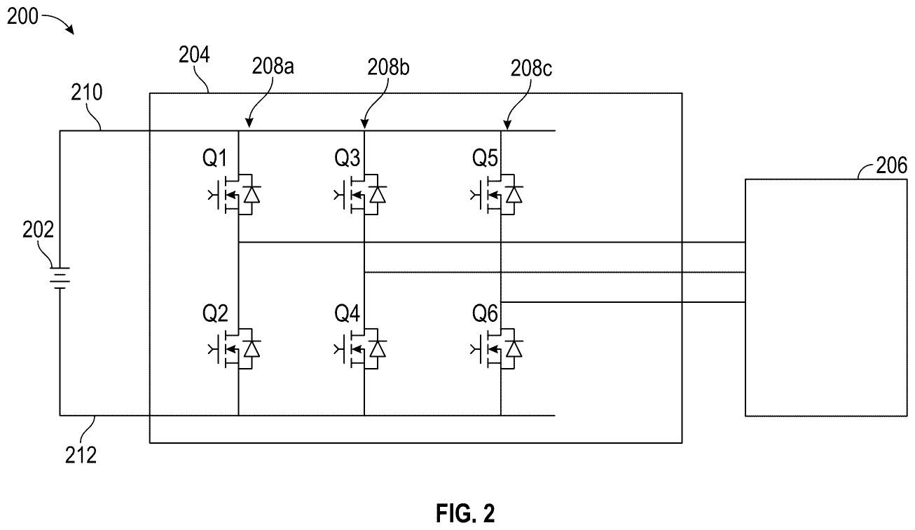

FIG. 2 shows an electrical system 200 of the vehicle 10 of FIG. 1 in an illustrative embodiment. The electrical system 200 includes a direct current (DC) power source (such as battery 202), an inverter 204 that converts the DC power from the battery 202 to AC power, and an electric motor 206 that operates using the AC power. The electric motor 206 is generally a 3-phase motor. The inverter 204 includes at least three branches (a first branch 208a, a second branch 208b, and a third branch 208c), which are out of phase with each other by about 120 degrees. Each branch includes a pair of switches which control conversion of the DC power to AC power along the branch. The first branch 208a includes switches Q1 and Q2. The second branch 208b includes switches Q3 and Q4. The third branch 208c includes switches Q5 and Q6. In an embodiment, a switch includes a transistor having a diode that spans from the source of the transistor to the drain of the transistor. A gate voltage can be applied at the gate of the transistor to control the flow of current through the transistor. The transistor can be an insulated-gate bipolar transistor (IGBT) or a metal-oxide-semiconductor field-effect transistor (MOSFET) or any other suitable transistor.

The battery 202 is connected to the inverter via a positive bus line 210 and a negative bus line 212.

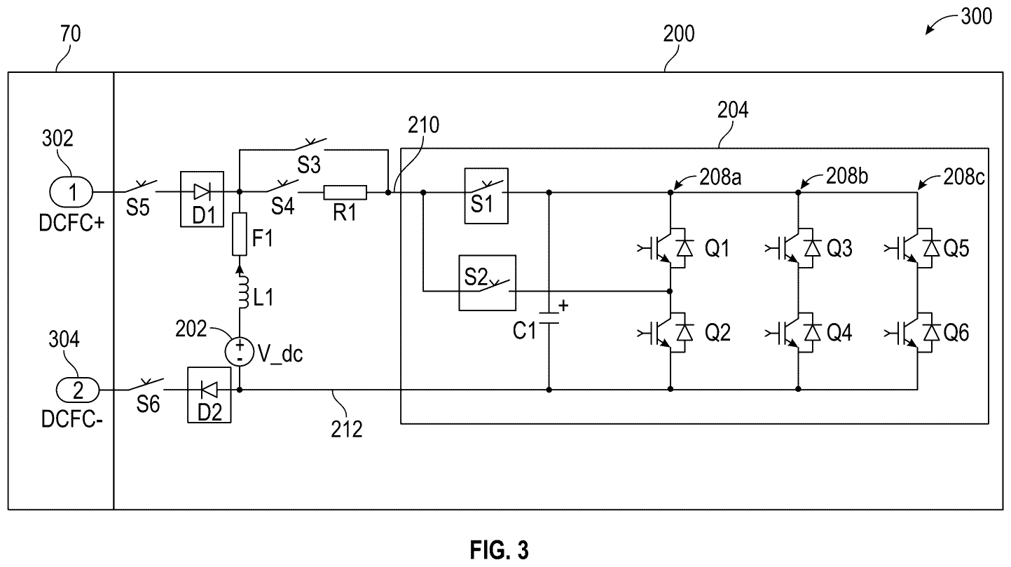

FIG. 3 shows a circuit 300 illustrating a charging operation for the vehicle, in an embodiment. The circuit 300 includes the electrical charging station 70 and the electrical system 200. The battery 202 and the inverter 204 of the electrical system 200 are shown.

A first contactor S1 controls a connection along the positive bus line 210 between the battery 202 and the inverter 204. A second contactor S2 controls a connection between the positive bus line 210 and a midpoint along the first branch 208a between the switches Q1 and Q2. A third contactor S3 and a fourth contactor S4 control electrical connectivity between the battery 202 and the inverter along the positive bus line 210 during a pre-charge sequence of a charging operation. The controller 65 can be used to control the operations of the first contactor S1, second contactor S2, third contactor S3 and fourth contactor S4.

The electrical charging station 70 includes a positive direct current fast charging port (positive DCFC port 302) and a negative direct current fast charging port (negative DCFC port 304). A positive bus charging contactor S5 controls a connection between the positive bus line 210 and the positive DCFC port 302 and a negative bus charging contactor S6 controls a connection between the negative bus line 212 and the negative DCFC port 304. A first diode D1 is disposed on the positive bus line 210. A second diode D2 is disposed on the negative bus line 212. The directions of the first diode D1 and the second diode D2 are selected to prevent a reverse flow of current from the vehicle into the electrical charging station 70.

The electrical charging station 70 charges the vehicle in two phases: a constant current phase and a constant voltage phase that follows the constant current phase. During the constant current phase, a DCFC baseline charging current is supplied to the battery 202. The first contactor S1 and the second contactor S2 can be controlled to generate a ripple current in the baseline charging current. The ripple current is superimposed over the baseline charging current to form a combined charging current. The combined charging current is used to charge the battery and reduces the time required for the charging operation (increases the charging rate).

The ripple current is generated by controlling the first contactor S1 and the second contactor S2, as well as switches Q1 and Q2. The ripple current can be a sinusoidal current.

Since the first contactor S1, second contactor S2, first diode D1, and second diode D2 are part of the electrical system, no additional circuitry is needed to create the ripple current. In particular, the first contactor S1 and the second contactor S2 are parts of the inverter 204.

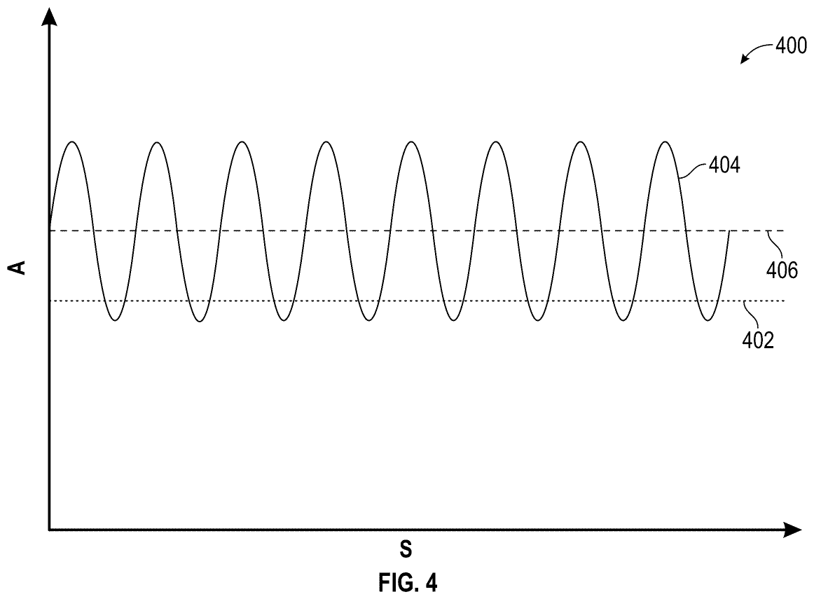

FIG. 4 shows a graph 400 illustrating a relation between current and time during a charging operation. Time is shown along the abscissa in seconds(s) and current is shown along the ordinate axis in amps (A). The graph 400 shows the baseline charging current 402 and a ripple current profile 404. RMS pulse charging current 406 represents the root mean square current of the combined charging current. The RMS pulse charging current 406 is greater than the baseline charging current 402, due to a relaxed lithium plating limit. Thus, the RMS pulse charging current 406 allows for quicker charging of the battery, as compared to the charging rate using the baseline charging current 402.

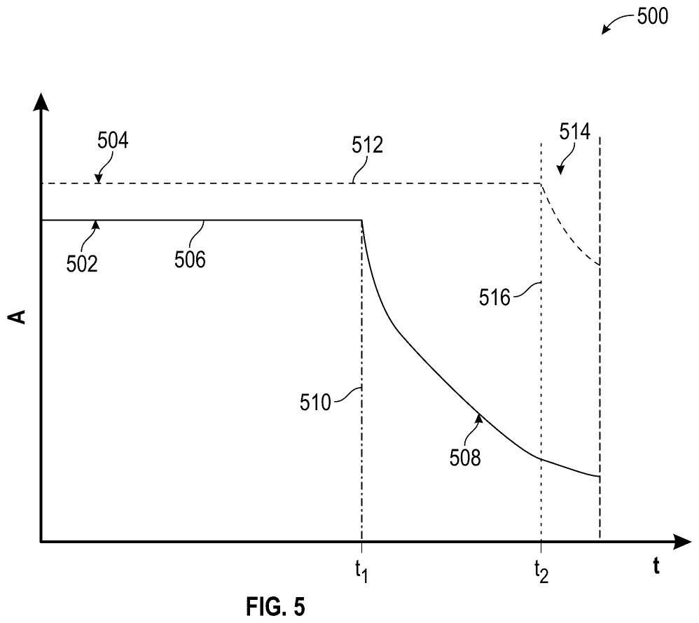

FIG. 5 is a graph 500 illustrating a relation between charging current and state of charge for different charging operations. Time (t) is shown along the abscissa and RMS current (A) is shown along the ordinate axis. A first curve 502 represents current during a standard DCFC charging using a baseline charging current (no ripple current added) and a second curve 504 represents current during DCFC pulsed charging (ripple current superimposed over a baseline charging current). The first curve 502 displays a baseline constant current phase 506 (at a first power) followed by a baseline constant voltage phase 508. The baseline constant current phase 506 lasts until first phase transition time 510 (at t₁), after which the baseline constant voltage phase 508 is used to charge the battery 202.

The second curve 504 displays a pulsed constant current phase 512 (at a second power) followed by a pulsed constant voltage phase 514. The pulsed constant current phase 512 lasts until second phase transition time 516 (t₂), after which the pulsed constant voltage phase 514 occurs. The second phase transition time 516 occurs later than the first phase transition time 510 because the ripple current applied in the pulsed constant current phase 512 is more effective at charging than the baseline constant current phase 506. In addition, the pulsed RMS current during the pulsed constant current phase 512 is greater than the baseline current during the baseline constant current phase 506. For each charging operation, the charging current decays during the pulsed constant voltage phase. The amount of decay of the charging current in the pulsed constant voltage phase 514 is less than the amount of decay of the charging current during the baseline constant voltage phase 508. This difference is due to the fact that the second phase transition time 516 occurs later than the first phase transition time 510. Therefore, the duration of the pulsed constant voltage phase 514 is shorter than the duration of the baseline constant voltage phase 508. Thus, there is less time for the decay to occur in the pulsed constant voltage phase 514 than in the baseline constant voltage phase 508.

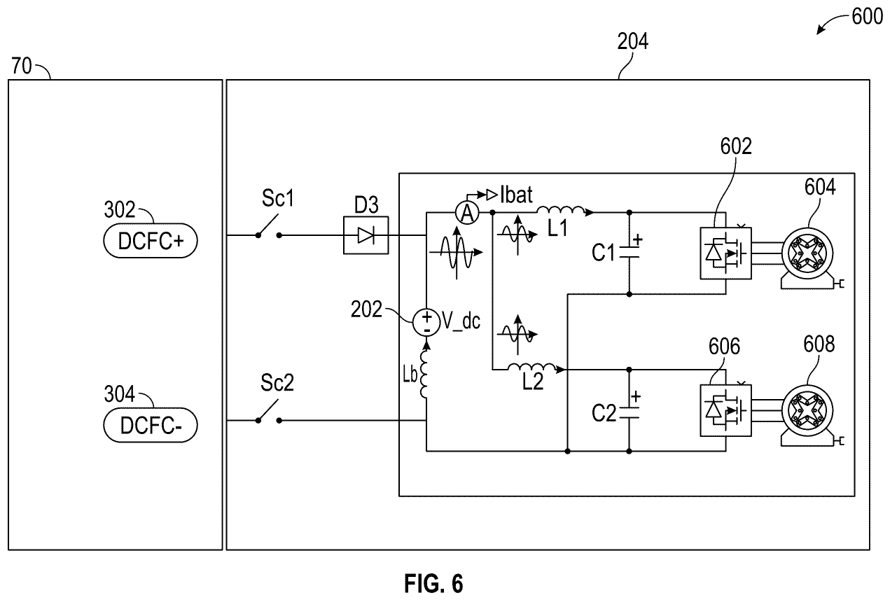

FIG. 6 is a diagram 600 of an electrical system with multiple inverters and motors. For illustrative purposes, the electrical system includes a first inverter 602, a first motor 604, a second inverter 606 and a second motor 608. The battery 202 is connected to both the first inverter 602 and the second inverter 606. The phase legs of each inverter can be controlled to generate AC heating current through the battery without producing any unwanted torque disturbances in the motors. A single diode D3 is used to prevent reverse flow of current from the electrical system to the charging station.

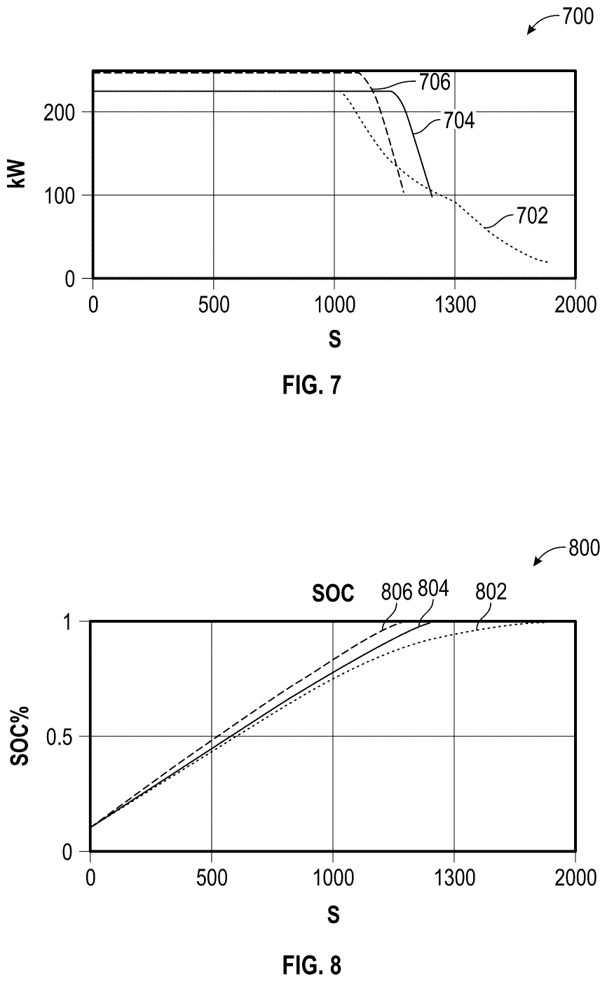

FIG. 7 shows a graph 700 of charging power over time. Time is shown along the abscissa in seconds(s) and module power is shown along the ordinate axis in kiloWatts (kW). It is understood that the numerical markers along each axis are provided for illustrative purposes only and are not meant as a limitation of the methods disclosed herein. The graph 700 includes a first power curve 702 indicative of a baseline charging operation, a second power curve 704 indicative of a pulsed charging operation (with ripple current), and a third power curve 706 indicative of pulsed charging with power increased to 1.1 times the maximum power of the baseline charging. As shown by first power curve 702, the baseline charging power is about 220 kW during a constant current phase (from about t=0 to about t=1050 seconds). During the constant voltage phase (after about t =1050 seconds), the charge power decreases until the battery 202 is fully charged (at about t=1880 seconds).

As shown by the second power curve 704, the pulsed charging power is about 220 kW during a constant current phase (from about t=0 to about t=1250 seconds). During the constant voltage phase (after about t=1250 seconds), the pulsed charging power decreases until the battery 202 is fully charged (at about t=1400 seconds).

As shown by the third power curve 706, the pulsed charging with increased power is about 220 kW during a constant current phase (from about t=0 to about t=1150 seconds). During the constant voltage phase (after about t=1150 seconds), the pulsed charge power with increased power decreases until the battery 202 is fully charged (at about t=1290 seconds).

FIG. 8 shows a graph 800 of state of charge (SOC) over time. Time is shown along the abscissa in seconds(s) and SOC is shown along the ordinate axis as a percentage (SOC %) of maximum SOC. The graph 800 includes a first SOC curve 802 indicative of a baseline charging operation, a second SOC curve 804 indicative of a pulsed charging operation, and a third SOC curve 806 indicative of pulsed charging with power increased to 1.1 times the maximum power of the baseline charging. The first SOC curve 802 reaches 100% charge at about t=1880 seconds. The second SOC curve 804 reaches 100% charge at about t=1400 seconds. The third SOC curve 806 reaches 100% charge at about t=1290 seconds.

Pulsed charging can be used to heat the battery, especially when changing occurs at low temperatures. When the temperature of the battery is low, the magnitude of the ripple current can be sized to prioritize the occurrence heating of the battery. This heating effects can be used in conjunction with an existing onboard battery heater to increase the heating rate over heating by either the onboard battery heater and the ripple current on their own.

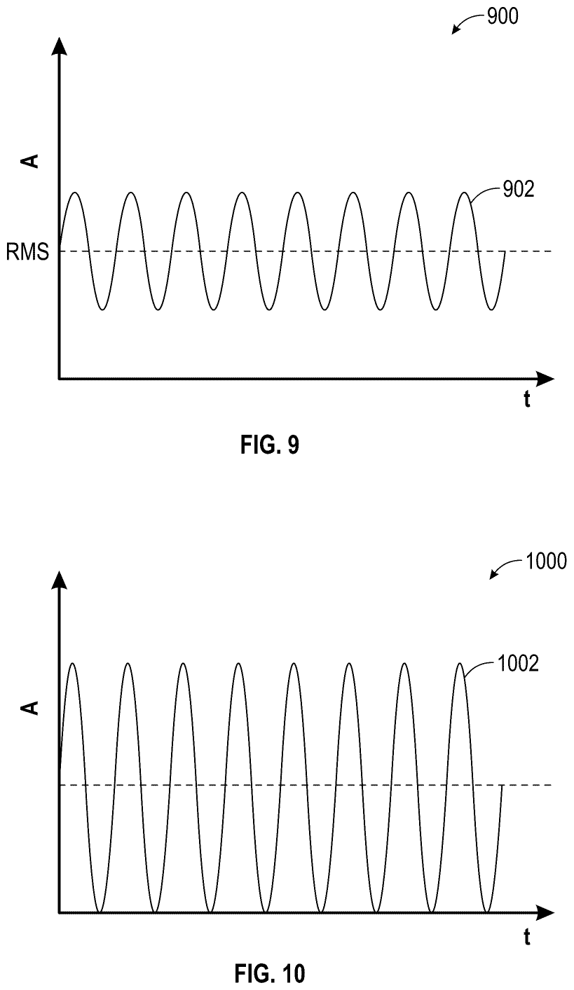

FIG. 9 is a graph 900 showing a low amplitude ripple current 902 that can be used for charging. Time (t) is shown along the abscissa and current (A) is shown along the ordinate axis. The low amplitude ripple current 902 remains close to the root mean square (RMS) of the charging current. Therefore, the charging current is always a positive value. The low amplitude ripple current 902 is ideal for use in a later portion of a charging operation and in a constant voltage phase.

FIG. 10 is a graph 1000 showing a mid-range amplitude ripple current 1002 that can be used for charging. Time (t) is shown along the abscissa and current (A) is shown along the ordinate axis. The peak-to-peak voltage of the mid-range amplitude ripple current 1002 is such that the charging current drops to zero once per cycle. Therefore, the mid-range amplitude ripple current 1002 inhibits the occurrence of plating at the lithium-ion battery while providing heating to the battery. The mid-range amplitude ripple current 1002 is ideal for early stages of charging (CC).

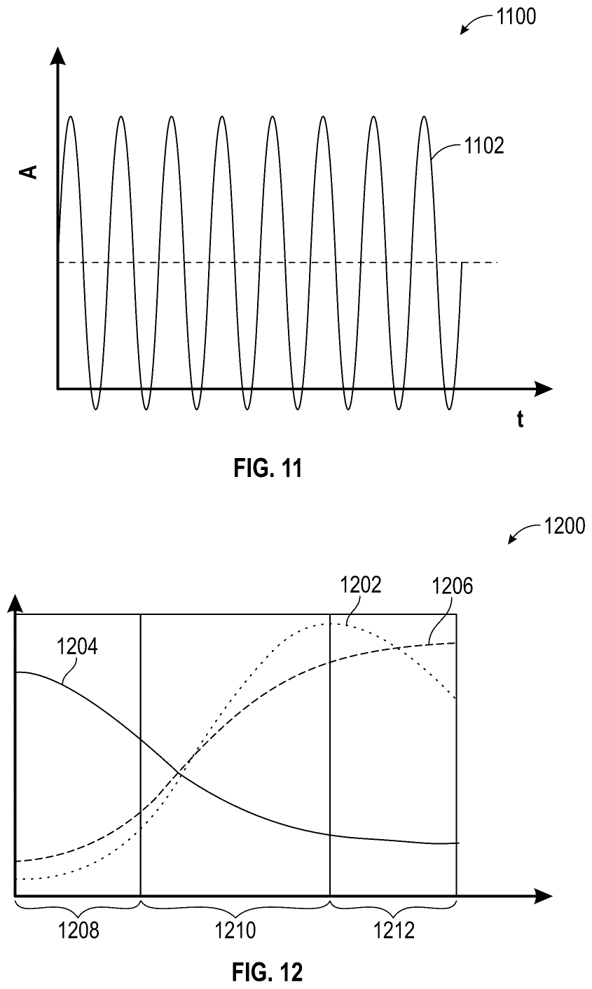

FIG. 11 is a graph 1100 showing a high amplitude ripple current 1102 that can be used for charging. Time (t) is shown along the abscissa and current (A) is shown along the ordinate axis. The peak-to-peak voltage of the high amplitude ripple current 1102 is such that the charging current drops below zero once per cycle. Therefore, the high amplitude ripple current 1102 strongly inhibits the occurrence of plating at the lithium-ion battery while providing high levels of heating at the battery. The high amplitude ripple current 1102 is ideal for early stages of charging (CC) and low temperature conditions.

FIG. 12 is a diagram 1200 showing a heating and pulse charging strategy. A first curve 1202 shows a charging rate of the charging operation. A second curve 1204 shows a pulse rate of the charging operation. A third curve 1206 shows a temperature of the battery. The strategy includes three stages. In a first stage 1208, the primary goal is to boost battery temperature as quickly as possible. In the second stage 1210, the goal is to accelerate charging speed. In the third stage 1212, the goal is to pulse charge until the battery is fully charged.

In the first stage 1208, there is a low charging rate (first curve 1202) and a high pulse rate (second curve 1204). The temperature of the battery (third curve 1206) is low. In the second stage 1210, the charging rate (first curve 1202) increases while the pulse rate (second curve 1204) decreases, thereby warming the battery, as shown by third curve 1206. In the third stage 1212, the charging rate(first curve 1202) is reduced. The pulsing rate (second curve 1204) is maintained while the cell temperature (third curve 1206) increases until the battery is fully charged.

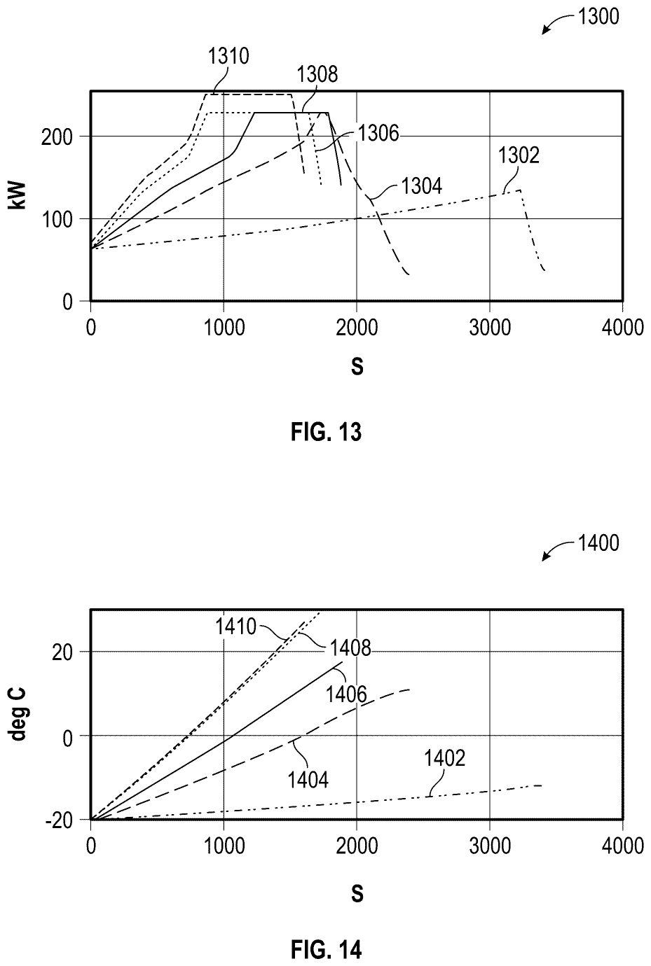

FIG. 13 is a graph 1300 showing charging power for various charging methods for a cold battery. Time is shown in seconds(s) along the abscissa and module power is shown in kiloWatts (kW) along the ordinate axis. For illustrative purposes, the temperature of the battery starts at −20 degrees. Time is shown along the abscissa in seconds(s) and module power is shown along the abscissa in kiloWatts (kW). A first curve 1302 shows power for a baseline charging operation. A second curve 1304 shows power for baseline charging with 0.5 deg/min of external heating, such as from an external heat source. A third curve 1306 shows power for pulsed charging with no external heating. A fourth curve 1308 shows power for pulsed charging with 0.5 deg/min of external heating. A fifth curve 1310 shows power for pulsed charging with 0.5 deg/min of external heating and with 1.1 times the power of the baseline charging operation.

The duration of the charging operation changes between charging operations. The baseline charging operation (first curve 1302) completes at about 3400 seconds. The baseline charging with 0.5 deg/min of external heating (second curve 1304) completes at about 2400 seconds. Pulsed charging with no external heating (third curve 1306) completes at about 1900 seconds. Pulsed charging with 0.5 deg/min of external heating (fourth curve 1308) completes at about 1735 seconds.

Pulsed charging with 0.5 deg/min of external heating and with 1.1 times the power of the baseline charging operation (fifth curve 1310) completes at about 1600 seconds.

FIG. 14 is a graph 1400 showing battery temperatures for various charging methods for a cold battery. Time is shown along the abscissa in seconds(s) and temperature is shown along the abscissa in degrees Celsius (degC). A first curve 1402 shows the battery temperature for a baseline charging operation. A second curve 1404 shows battery temperature for baseline charging with 0.5 deg/min of external heating. A third curve 1406 shows battery temperature for ripple charging with no external heating. A fourth curve 1408 shows battery temperature for ripple charging with 0.5 deg/min of external heating. A fifth curve 1410 shows battery temperature for ripple charging with 0.5 deg/min of external heating and with 1.1 times the power of the baseline charging operation.

During the baseline charging operation (first curve 1402), the battery temperature rises only slightly to about −15 degC. During the baseline charging with 0.5 deg/min of external heating (second curve 1404), the battery temperature rises to about 10 degC. During ripple charging with no external heating (third curve 1406), the battery temperature rises to about 18 degC. During ripple charging with 0.5 deg/min of external heating (fourth curve 1408), the battery temperature rises to about 25 degC. During ripple charging with 0.5 deg/min of external heating and with 1.1 times the power of the baseline charging operation (fifth curve 1410), the battery temperature reaches about 23 degC.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on”another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of charging a battery of a vehicle, comprising:
receiving a baseline charging current from a charging station coupled to an electrical system of the vehicle, the electrical system including the battery, an inverter, and a positive bus line connecting the battery to the inverter and connecting the battery to the charging station, wherein the inverter includes a first contactor for connecting the battery and the inverter along the positive bus line;
controlling the first contactor to generate a ripple current on the positive bus line;
superimposing the ripple current over the baseline charging current to obtain a combined charging current; and
charging the battery using the combined charging current.

2. The method of claim 1, wherein a charging operation includes a constant current phase, further comprising charging the battery using the combined charging current during the constant current phase.

3. The method of claim 1, wherein the electrical system includes a second contactor between the positive bus line and a midpoint of a branch of the inverter, further comprising controlling the first contactor and the second contactor to generate the ripple current.

4. The method of claim 1, wherein a charging operation includes a constant current phase and a constant voltage phase, further comprising charging the battery using the combined charging current to reduce a duration of the constant voltage phase.

5. The method of claim 1, further comprising controlling an amplitude of the ripple current to perform at least one of: (i) inhibiting an occurrence of plating at the battery; and (ii) heating the battery.

6. The method of claim 1, further comprising applying heat to the battery via at least one of: (i) an external heat source and (ii) the ripple current.

7. The method of claim 1, further comprising providing the baseline current at a first power, superimposing the ripple current over the baseline current to generate the combined charging current at the first power, and increasing the combined charging current from the first power to a second power greater than the first power.

8. An electrical system of a vehicle, comprising:
a battery;
an inverter coupled to the battery via a positive bus line;
a first contactor within the inverter that connects the battery to the inverter via the positive bus line;
a charge port for connecting the positive bus line to a charging station for receiving a baseline charging current from the charging station; and
a processor configured to control the first contactor to generate a ripple current in the positive bus line, wherein the ripple current is superimposed over the baseline charging current to obtain a combined charging current for charging the battery.

9. The electrical system of claim 8, wherein a charging operation includes a constant current phase and the processor is further configured to charge the battery using the combined charging current during the constant current phase.

10. The electrical system of claim 8, wherein the electrical system includes a second contactor between the positive bus line and a midpoint of a branch of the inverter and the processor is further configured to control the first contactor and the second contactor to generate the ripple current.

11. The electrical system of claim 8, wherein a charging operation includes a constant current phase and a constant voltage phase and the processor is further configured to charge the battery using the combined charging current to reduce a duration of the constant voltage phase.

12. The electrical system of claim 8, wherein the processor is further configured to control an amplitude of the ripple current to perform at least one of: (i) inhibiting an occurrence of plating at the battery; and (ii) heating the battery.

13. The electrical system of claim 8, wherein heat is applied to the battery via at least one of: (i) an external heat source and (ii) the ripple current.

14. The electrical system of claim 8, wherein the processor is further configured to provide the baseline current at a first power, superimpose the ripple current over the baseline current to generate the combined charging current at the first power, and increase the combined charging current from the first power to a second power greater than the first power.

15. A vehicle, comprising:
an electrical system including:
a battery;
an inverter coupled to the battery via a positive bus line;
a first contactor within the inverter that connects the battery to the inverter via the positive bus line;
a charge port for connecting the positive bus line to a charging station for receiving a baseline charging current from the charging station;
a diode for preventing a reverse flow of current from the electrical system to the charging station; and
a processor configured to control the first contactor to generate a ripple current in the positive bus line, wherein the ripple current is superimposed over the baseline charging current to obtain a combined charging current, wherein the combined charging current is used to charge the battery.

16. The vehicle of claim 15, wherein a charging operation includes a constant current phase and the processor is further configured to charge the battery using the combined charging current during the constant current phase.

17. The vehicle of claim 15, wherein the electrical system includes a second contactor between the positive bus line and a midpoint of a branch of the inverter and the processor is further configured to control the first contactor and the second contactor to generate the ripple current.

18. The vehicle of claim 15, wherein a charging operation includes a constant current phase and a constant voltage phase and the processor is further configured to charge the battery using the combined charging current to reduce a duration of the constant voltage phase.

19. The vehicle of claim 15, wherein the processor is further configured to control an amplitude of the ripple current to perform at least one of: (i) inhibiting an occurrence of plating at the battery; and (ii) heating the battery.

20. The vehicle of claim 15, wherein the processor is further configured to provide the baseline current at a first power, superimpose the ripple current over the baseline current to generate the combined charging current at the first power, and increase the combined charging current from the first power to a second power greater than the first power.
